(19) United States
(12) Patent Application Publication
(10) Pub. No.: US 2006/0126584 A1
(43) Pub. Date: Jun. 15, 2006

(54) Method for user equipment selection of a packet data gateway in a wireless local network

(75) Inventors: Wenlin Zhang, Shenzhen (CN); Yingxin Huang, Shenzhen (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Huawei Technologies Co., Ltd., Shenzhen (CN)

(21) Appl. No.: 11/262,177

(22) Filed: Oct. 28, 2005

Related U.S. Application Data
(63) Continuation of application No. PCT/CN04/01215, filed on Oct. 26, 2004.

(30) Foreign Application Priority Data
Dec. 12, 2003 (CN) 200310121351.X

(51) Int. Cl. H04Q 7/24

(52) U.S. Cl. 370/338

(57) ABSTRACT

Disclosed herein is a method for Wireless Local Area Network (WLAN) User Equipment (UE) selection of a Packet Data Gateway (PDG). When the WLAN UE fails to access, the PDG returns a message containing the failure cause value to the WLAN UE that has sent the request such that the WLAN UE could perform different operations according to the specific failure cause value in the message to select a PDG. For example, the WLAN UE may request DNS again to obtain the IP address of the PDG in a home network by parsing in connection with a requested service, or the WLAN UE may first subscribe to the service before re-performing the operation of selecting a PDG, or the WLAN UE may re-select a PDG with another parsed IP address and send a connection request thereto. As a result, the process of WLAN UE asking DNS to re-direct to the home network to select PDG is left out when possible, unnecessary signaling is avoided, and the network resources are saved.

### CROSS-REFERENCES TO RELATED APPLICATIONS

This is a continuation of International Application No. PCT/CN2004/001215, which was filed on Oct. 26, 2004, and which, in turn, claimed the benefit of Chinese Patent Application No. 200310121351.X, which was filed on Dec. 12, 2003, the entire disclosures of which are hereby incorporated herein by reference.

### BACKGROUND OF THE DISCLOSURE

1. Field of the Technology

The present invention relates to wireless access techniques and, more particularly, to User Equipment (UE) in a Wireless Local Area Network (WLAN) selection of a Packet Data Gateway (PDG).

2. Background of the Invention

Along with other societal developments, user demands on wireless access rates are becoming higher and higher. As WLANs are able to provide a higher wireless access rate of data in a relatively small area, WLANs are widely used nowadays. WLANs involve various kinds of techniques, the one most extensively used being the technical standard IEEE 802.11b, whose frequency band is 2.4 GHz and data transmission rate is up to 11 Mbps. Other technical standards using the same frequency band include IEEE 802.11g and Bluetooth, where the data transmission rate of IEEE 802.11g is up to 54M bps. Other standards of WLANs, such as IEEE 802.11a and ETSI BRAN Hiperlan2, use the frequency band of 5 GHz, and the transmission rate of which can be up to 54 Mbps as well.

Although WLANs involve various kinds of wireless access techniques, most WLAN techniques utilize IP data packets for data transmission. The specific WLAN access technique adopted by a wireless IP network is usually transparent to the upper IP level. Such a wireless IP network is usually configured with Access Points (AP) for implementing wireless access of UEs, and with controlling and connecting devices for implementing IP data transmission.

Along with the appearance and development of WLANs, the inter-working of WLANs with various wireless mobile communication networks, such as GSM, CDMA. WCDMA, TD-SCDMA, and CDMA2000, has becoming the focus of research. In accordance with the 3 GPP (3rd Generation Partner Project) standards, UE is not only able to connect with the Internet and Intranet via the access network of WLAN, but is also able to connect with a home network and visiting network of a 3 GPP system via the WLAN access network.

FIG. 1. is a schematic diagram illustrating the architecture of the networking of WLAN system and 3 GPP system under roaming conditions. When a WLAN UE accesses the network in a roaming state, it is able to connect to the visiting network of the 3 GPP system via the WLAN access network. And as some entities of the 3 GPP visiting network are connected with some corresponding entities of the 3 GPP home network, for instance, the 3 GPP Authentication, Authorization and Accounting (AAA) Proxy in the 3 GPP visited network is connected to the 3 GPP AAA Server in the 3 GPP home network, the WLAN Access Gateway (WAG) in the 3 GPP visited network is connected to the Packet Data Gateway (PDG) in the 3 GPP home network, and etc., the WLAN UE is able to access the 3 GPP home network via said connections. The dashed area of FIG. 1 illustrates the Packet Switching (PS) domain service of 3 GPP, i.e. the Inter-working Scenario 3 services in a 3 GPP network.

FIG. 2 is a schematic diagram illustrating the architecture of the networking of WLAN system and 3 GPP system under non-roaming conditions. When a WLAN UE accesses the network locally, it will get connected directly to the 3 GPP home network via the WLAN access network. The dashed area of FIG. 2 illustrates the 3 GPP PS domain service, i.e. the Scenario 3 services in the 3 GPP home network.

As shown in FIG. 1 and FIG. 2, a 3 GPP system primarily includes Home Subscriber Server (HSS)/Home Location Register (HLR), 3 GPP AAA Server, 3 GPP AAA Proxy, WAG, PDG, Charging Gateway (CGw)/Charging information Collecting Function (CCF) and Online Charging System (OCS). WLAN UE, WLAN access network, and all the entities of the 3 GPP system together construct a 3 GPP-WLAN inter-working network, which can be used as a WLAN service system. In this service system, 3 GPP AAA Server is in charge of the authentication, authorization, and accounting for a WLAN UE, collecting the charging information sent from the WLAN access network and transferring said charging information to the charging system; PDG is in charge of the transmission of the user's data from the WLAN access network to the 3 GPP network or other packet switching networks; and the charging system is in charge of receiving and recording the user's charging information transferred from the network, where OCS takes charge of instructing the network to periodically transmit online charging information in accordance with the expenses of the online charged users, meanwhile making statistics and controlling the network.

In the non-roaming case, when a WLAN UE desires to access the Internet/Intranet directly, the WLAN UE can access the Internet/Intranet via the WLAN access network after accomplishing the authentication process with AAA server (AS) via the WLAN access network. If the WLAN UE desires to access the services of 3 GPP PS domain as well, it should further request the services of Scenario 3 from the 3 GPP home network. The method for requesting a Scenario 3 services is as follows.

The WLAN UE first provides an identifier of the access point name (W-APN) of the service that the WLAN UE requests to a Domain Name Server (DNS). The DNS may be a third-party public device or a public domain name service device private to the wireless network. The DNS accepting the request provides the corresponding IP address(es) of one or a plurality of PDGs by resolving the W-APN identifier provided by the WLAN UE, and returns the IP addresses to the WLAN UE. The WLAN UE sends a request for setting up a tunnel connection to a PDG corresponding to one of the IP addresses obtained from the DNS. The PDG receiving the tunnel connection request from the WLAN UE contacts with AS, which is in charge of making service identity checking and authorization to the WLAN UE. If the access authentication succeeds, the PDG that has received the connection request of the WLAN UE will set up a tunnel connection with the WLAN UE that has sent the request, thereby implementing the application of the Scenario 3 services. If the access authentication fails, the PDG receiving the request for connection from the WLAN UE will notify the WLAN UE that the access authentication has failed.

In the roaming case, if a WLAN UE desires to access the Internet/Intranet directly, the WLAN UE will make a request to the 3 GPP home network via the 3 GPP visited network for accessing the Internet/Intranet. After a successful access authentication, the WLAN UE can access Internet/Intranet via the WLAN access network. If the WLAN UE desires to request a Scenario 3 services as well, the method for requesting a Scenario 3 services is as follows.

The WLAN UE first provides a W-APN identifier of the service that the WLAN UE requests to a DNS. The DNS receiving the request provides the IP address(es) of one or a plurality of corresponding PDGs by resolving the W-APN identifier provided by the WLAN UE, and returns the addresses to the WLAN UE. The WLAN UE sends to a PDG corresponding to one of the IP addresses obtained from the DNS a request for setting up a tunnel connection. The PDG receiving the connection request from the WLAN UE contacts with the AS of the current network, which will further contact the AS of the home network of the WLAN UE for service identity checking and authorization to the WLAN UE. If the access authentication succeeds, the PDG that has received the connection request of the WLAN UE will set up a tunnel connection with the WLAN UE that has sent the request, thereby implementing the application of the Scenario 3 services. If the access authentication fails, the PDG that has received the request for connection from the WLAN UE will notify the WLAN UE that the access authentication has failed.

After receiving the notification of an unsuccessful authentication from the PDG, the WLAN UE will contact the DNS again, requesting the DNS to resolve W-APN to obtain the IP addresses of PDGs in the home network in accordance with the requested service. The DNS provides one or a plurality of IP addresses of PDGs in the home network of the UE by resolving the W-APN provided by the UE and returns the addresses to the WLAN UE. The WLAN UE will send a request for setting up a tunnel connection once again to a PDG corresponding to one of the IP addresses. The PDG that has received the connection request from the WLAN UE contacts the AS of the current network, which will further contact the AS of the home network of the WLAN UE for service identity checking and authorization to the WLAN UE. If the access authentication succeeds, the PDG that has received the connection request of the WLAN UE will set up a tunnel connection with the WLAN UE that has sent the request, thereby implementing the application of the Scenario 3 services.

The drawbacks of the above described method lie in when a WLAN UE requests the service of a PDG in the network. If the request fails, the PDG will only notify the WLAN UE that the access fails. Thus the WLAN UE will not know the specific reason for failure. In this case, if the WLAN UE is roaming, it will directly contact the DNS and re-route to the home network to select the needed PDG, which leads to extra signaling processes and will further bring unnecessary occupation of network resources.

### SUMMARY OF THE INVENTION

In accordance with one aspect of the disclosure, a method is useful for PDG re-selection where a WLAN UE will be able to re-select a PDG in connection with an access failure. The disclosed method for a WLAN UE selecting a PDG includes the step of said WLAN UE obtaining the IP addresses of one or a plurality of PDGs via a DNS, based on the W-APN identifier constructed according to the selected service by the user, selecting one of the obtained IP addresses, and sending a request for setting up a tunnel connection to a PDG corresponding to the selected IP address. The disclosed method further includes the step of said PDG receiving the connection request of said WLAN UE judging whether to permit said WLAN UE that has sent the request to access, and if yes, setting up a tunnel connection with said WLAN UE that has sent the request, providing said WLAN UE with the requested service, and ending the process; otherwise sending a message containing the reason value of failure to said WLAN UE that has requested to access, and proceeding to a step in which said WLAN UE selects a new PDG to connect with according to the failure cause value in the returned said failure message.

In accordance with further aspects of the disclosure, when a WLAN UE fails to access, the PDG will return a message containing the failure cause value to the WLAN UE that has sent the request such that the WLAN UE could perform different operations to select a PDG according to the specific failure cause value in the message. For example, the WLAN UE may perform the DNS query once again to obtain the IP addresses of PDGs in the home network in accordance with the service requested, or the WLAN UE may subscribe the services before re-performing the operations of selecting a PDG, or the WLAN UE may re-select one of the obtained PDGs and initiate a connection request to the selected PDG. In accordance with the disclosure, the process of a WLAN UE making DNS re-direct to the homework to select a PDG is left out, unnecessary signaling messages are avoided, and network resources are saved.

### BRIEF DESCRIPTION OF THE DRAWINGS

FIG. 1 is a schematic diagram illustrating the architecture of the inter-working network of WLAN and 3 GPP system under roaming conditions;

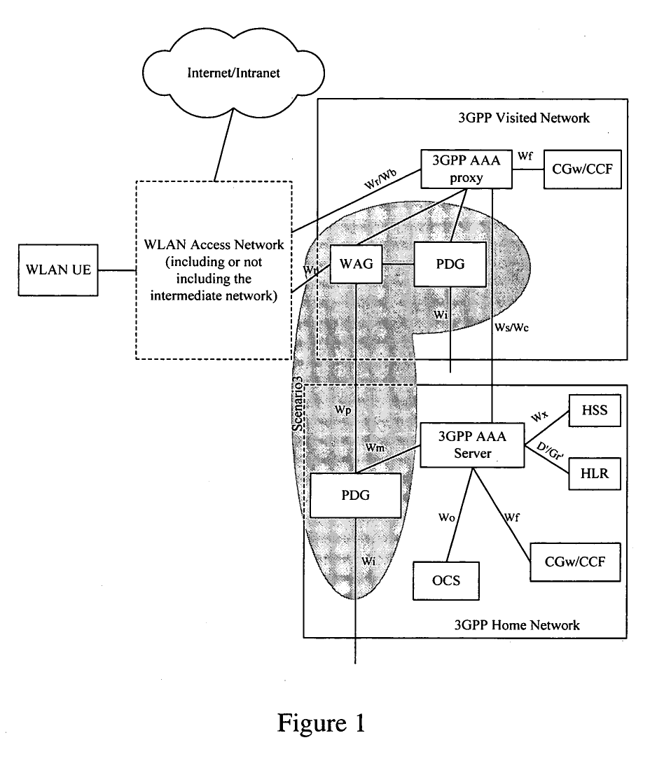

FIG. 2 is a schematic diagram illustrating the architecture of the inter-working network of WLAN and 3 GPP system under non-roaming conditions;

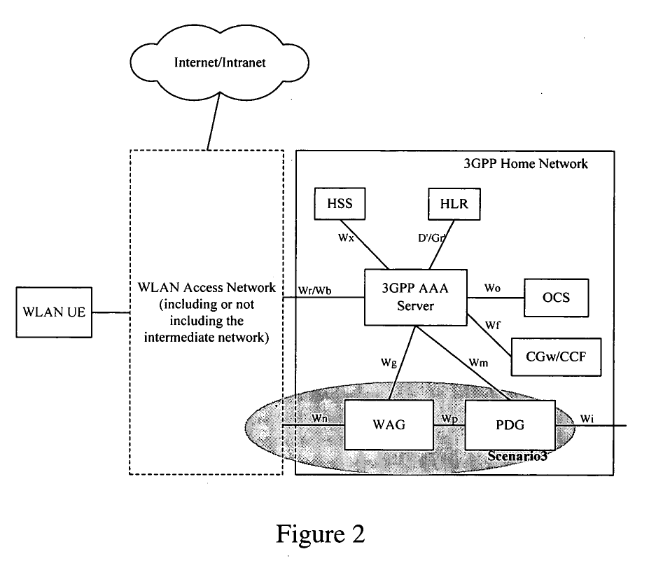

FIG. 3 is the flowchart for a WLAN UE to select a PDG in accordance with one embodiment of the disclosed method.

### DETAILED DESCRIPTION OF PREFERRED EMBODIMENTS

In order to make the solution in accordance with the present disclosure clearer, a number of preferred embodiments of the present disclosure are hereinafter described in more detail with reference to the accompanying drawings.

In accordance with one aspect of the disclosure, when the WLAN UE fails to access a PDG in the network, the PDG will return to the WLAN UE a message containing the failure cause value; after receiving this message containing the failure cause value, the WLAN UE will perform different operations to re-select a PDG according to the specific failure cause value.

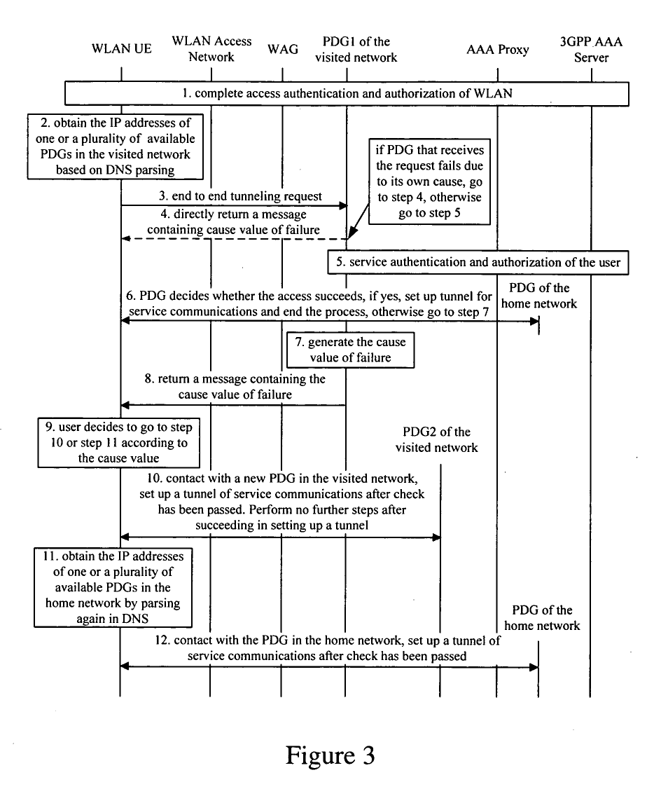

FIG. 3 is the flowchart for a WLAN UE to select a PDG in accordance with one embodiment.

Step 1: when a WLAN UE accesses the network, it should pass the basic authentication and authorization process first. After this authentication and authorization process, the WLAN UE may visit the Internet/Intranet via the access network.

Step 2: when the WLAN UE desires to use a 3 GPP PS service in the visited network, the WLAN UE first providing the W-APN identifier of the requested services to a DNS. The DNS that has received the request returns to the WLAN UE the IP addresses of one or a plurality of PDGs, where the IP addresses of one or a plurality of PDGs may be the IP addresses of one or a plurality of PDGs acquired through DNS query based on the W-APN identifier provided by the WLAN UE, or the IP addresses saved in the buffer of the DNS itself.

Typically, the DNS will save the IP addresses acquired through resolving in the buffer for a pre-set period of time, and when there is a request from other WLAN UE for resolving the same W-APN, DNS will merely return the IP addresses of the PDGs saved in its own buffer to the WLAN UE.

Step 3: the WLAN UE sending a request for setting up a tunnel connection to the PDG corresponding to one of the IP addresses obtained from the DNS.

If the PDG is unable to accept the request of the WLAN UE after receiving the message of the request for setting up a tunnel connection from the WLAN UE due to the limitation of its own flow volume or a temporary management control, or a mismatching of versions of the interactive protocols, proceed to step 4, and otherwise proceed to step 5.

If the WLAN UE does not receive any response in a pre-set period of time, for instance, the PDG may hang up, the WLAN UE will proceed to step 10, i.e. try the IP addresses of other PDGs returned by the DNS which have not been tried yet.

Step 4: before the authentication and authorization, the PDG which has received the request sending the message containing the failure cause value as the PDG is abnormal directly to the WLAN UE requesting to access, and directly proceeds to step 9.

Step 5: the PDG which has received the connection request from the WLAN UE making such operations as the service identity checking and authorization of the WLAN UE through interaction with the AAA server in the home network of the WLAN UE.

Step 6: the PDG judging, according to the information returned by AAA, whether to permit the WLAN UE to access, if permit, the PDG which has received the connection request of the WLAN UE setting up a tunnel connection with the WLAN UE that has sent the request, providing the WLAN UE with the requested service, and thereby implementing the application of a certain 3 GPP PS domain service and ending this process, and if not permitted, proceed to Step 7.

Step 7: the PDG generating the cause value of the access failure; if the WLAN UE is roaming, the cause value of the failure includes that the PDG selected by the WLAN UE is abnormal, or the currently visited network does not support the WLAN UE to use the requested service in the visited network, or the WLAN UE has not subscribed to the requested services; if the WLAN UE is in the non-roaming case, the failure cause value includes that the PDG selected by the WLAN UE is abnormal, or the WLAN UE has not subscribed to the requested services.

Step 8: the PDG returning the failure message containing the failure cause value to the WLAN UE which has made the connection request.

Step 9: the WLAN UE which has received the failure message containing the failure cause value, judging based on the content of the failure cause value in the message, if the failure cause value is that the PDG selected by the WLAN UE is abnormal, performs step 10. If the failure cause value is that the currently visited network does not support the WLAN UE to use the requested service in the visited network, then the WLAN UE performs Step 11. If the failure cause value is that the WLAN UE has not subscribed to the requested services, the WLAN UE will proceed to other processing procedures, such as carrying out an subscribing operation or giving up, and ending this process.

Step 10: the WLAN UE first judging whether there are in itself said plurality of IP addresses obtained through DNS query. If yes, the WLAN UE will select another IP address, and send a request for setting up a tunnel connection to the PDG corresponding to the re-selected IP address; then the PDG which has received the connection request of the WLAN UE makes further processing to the WLAN UE, such as service identity checking and authorization, by the AAA of the home network of the WLAN UE, if the WLAN UE is permitted to access, the PDG which has accepted the connection request of the WLAN UE setting up a tunnel connection with the WLAN UE which has sent the request, providing the WLAN UE with the requested services, thereby implementing the application of a certain 3 GPP PS domain services, and ending this process. In this way, the WLAN UE avoids being redirected to the PDG of the home network, making full use of the IP addresses of a number of PDGs returned by the DNS in the first process of DNS query. If the access authentication does not succeed, return to step 7.

If the WLAN UE receives only one IP address returned by DNS, the WLAN UE will judge whether the WLAN UE itself is roaming. If yes, the WLAN UE performs step 11, and otherwise ends this process.

Step 11: the WLAN UE performing the DNS query once again for the IP addresses of the PDGs in the home network according to the requested services. The DNS resolving W-APN and getting the IP addresses of one or a plurality of PDGs in the home network, and returning the addresses to the WLAN UE. The WLAN UE sending a request for setting up a tunnel connection to the PDG corresponding to one of the IP addresses acquired from the DNS.

Step 12: after completing the processing of service identity checking and authorization of the WLAN UE by AAA server of the home network of the WLAN UE, the PDG which has accepted the connection request of the WLAN UE setting up a tunnel connection with the WLAN UE which has sent the request, providing the WLAN UE with the requested service, thereby implementing the application of a certain 3 GPP PS domain service, and ending this process.

The above messaging process may be implemented by the existing Internet protocol-Layer 2 Tunnel Setup Protocol (L2TP). In the message format of the failure message returned by L2TP, there are a result code field and an error code field. By using different combinations of the two fields, the returned causes of failure in this embodiment can be differentiated.

For instance, if the WLAN UE learns that the value of the result code is “use without authorization” and the value of the error code is that there is no agreement in the currently visited network for the service requested by the WLAN UE, the WLAN UE will just redirect to the PDG of the home network. If the WLAN UE learns that the value of the result code is “use without authorization” and the value of the error code is that the user has not subscribed to the service, the WLAN UE will proceed to other processing procedures after receiving this message, e.g., making subscribing operation or giving up. If the WLAN UE learns that the value of the result code is “general error” and the value of the error code is “try another”, the WLAN UE believes that the PDG itself is abnormal. In this case, the WLAN UE needs not redirect to the PDG of the home network, and instead it will try to establish a connection with another PDG in the visiting network so as to save the signaling required for redirecting to the home network.

In addition, the protocol family of IP Security (IPsec) may also be used as the tunnel protocol as well, where the Internet Key Exchange (IKE) protocol or Internet Key Exchange protocol version 2 (IKEv2) may also be used as the bearing protocol in this embodiment. By utilizing the reserved fields in these protocols or making appropriate extensions thereto, the functions of this solution can be implemented.

The Internet Generic Routing Encapsulation (GRE) protocol is an encapsulation protocol supporting tunnel connections. The information about the cause of failure in this embodiment may be put into an IP packet and then encapsulated directly by the GRE protocol so as to implement the tunnel communications between the WLAN UE and PDG. For a better performance in security, it is recommended that the GRE protocol be used together with the IP Security protocol.

The foregoing description is directed to exemplary embodiments of the invention and is to be regarded as illustrative rather than restrictive. Any modification, equivalent substitution and improvement within the spirit and principle of this invention should be included in the protection scope thereof.

1. A method for Wireless Local Area Network (WLAN) User Equipment (UE) selecting Packet Data Gateway (PDG), comprising the steps of:
(A) said WLAN UE obtaining a plurality of IP addresses of one or a plurality of PDGs via a DNS, respectively, based on a W-APN identifier constructed by the user, selecting one of the obtained IP addresses, and sending a request for setting up a tunnel connection to a PDG corresponding to the selected IP address;
(B) said PDG receiving the connection request of said WLAN UE and judging whether to permit said WLAN UE that has sent the request to access, and if yes, setting up a tunnel connection with said WLAN UE that has sent the request, providing said WLAN UE with the requested service, and ending the selecting process; and otherwise sending a message containing a failure cause value to said WLAN UE that has requested to access, and proceeding to step (C); and,
(C) said WLAN UE selecting a new PDG to connect with according to the failure cause value in the returned said failure message.

2. The method according to claim 1, wherein said failure cause value in step (C) indicates that the PDG selected by said WLAN UE is abnormal, such that step (C) comprises said WLAN UE first judging whether said WLAN UE has said plurality of IP addresses obtained by the DNS query, and if yes, said WLAN UE selecting another IP address, sending a request for setting up a tunnel connection to the PDG corresponding to the selected IP address, and then continuing with step (B); and otherwise the WLAN UE further judging whether said WLAN UE is in a roaming case, and if yes, performing the DNS query once again to obtain the IP address of the PDG in a home network in accordance with the requested service, the DNS obtaining the IP addresses of one or a plurality of PDGs in the home network by DNS query according to the W-APN identifier provided by the WLAN UE before returning the IP addresses to the WLAN UE, and then said WLAN UE continuing with the subsequent steps, otherwise ending the selecting process.

3. The method according to claim 1, wherein said failure cause value in step (C) indicates that a currently visited network does not support said WLAN UE to use the requested service in the visited network, such that step (C) comprises the WLAN UE performing the DNS query once again to obtain the IP address of the PDG in a home network in accordance with the requested service, the DNS obtaining the IP addresses of one or a plurality of PDGs in the home network according to the W-APN identifier provided by said WLAN LE and returning the addresses to said WLAN LE, and then said WLAN LE continuing with the subsequent steps.

4. The method according to claim 1, wherein said failure cause value in step (C) indicates that said WLAN UE has not subscribed to the requested service, such that step (C) comprises said WLAN UE subscribing the requested service before re-performing the selecting process, or ending the selecting process.

5. The method according to claim 1, wherein said message containing the failure cause value returned by the PDG to said WLAN UE in step (B) is carried by L2TP (Layer 2 Tunneling Protocol), or Internet Key Exchange (IKE) Protocol, or Internet Key Exchange Protocol version 2 (IKEv2) or GRE (Generic Routing Encapsulation) protocol, or GRE protocol and IKE Protocol, or GRE protocol and IKEv2 Protocol.

6. The method according to claim 1, wherein said IP addresses of one or a plurality of PDGs obtained by the DNS in step (A) are acquired through DNS resolving, or from a buffer of the DNS.
